(19) United States
(12) Patent Application Publication
(10) Pub. No.: US 2026/0169439 A1
(43) Pub. Date: Jun. 18, 2026

(54) NAVIGATION SYSTEM FOR A WATCH

(71) Applicant: ETA SA MANUFACTURE HORLOGÈRE SUISSE, Grenchen (CH)

(72) Inventor: Emmanuel FLEURY, Moutier (CH)

(73) Assignee: ETA SA MANUFACTURE HORLOGÈRE SUISSE, Grenchen (CH)

(21) Appl. No.: 19/368,006

(22) Filed: Oct. 24, 2025

(30) Foreign Application Priority Data
Dec. 12, 2024 (EP) 24219342.3

(51) Int. Cl. G04B 47/06; G01C 21/20

(52) U.S. Cl. CPC G04B 47/065; G01C 21/20

(57) ABSTRACT

A navigation system (1) configured to guide a user along an itinerary leading to a determined geographic location, the system (1) including a watch (2) and a wireless electronic geolocation device (3) capable of generating guidance data relating to the itinerary, the watch (2) including an electronic horology movement (4) and a display interface (5) that alternately implements a mode for displaying horological information and a mode for displaying guidance information resulting from the guidance data using at least a first hand (7a) and a second hand (7b) included in the interface (5), the guidance information relating to indications of a set direction to be followed to reach the geographic location and to an estimated travel time to the next change of direction.

### CROSS-REFERENCE TO RELATED APPLICATIONS

This application claims priority to European Patent Application No. 24219342.3, filed on December 12, 2024, the entire contents of which are incorporated herein by reference.

### TECHNICAL FIELD OF THE INVENTION

The present invention relates to a guidance system for an electronic watch, designed to indicate the direction of a specific geographic location to a user wearing the watch.

### TECHNOLOGICAL BACKGROUND

Electronic watches have evolved to incorporate more and more functions. One of these functions is satellite positioning using a GPS module. Such a GPS module consists of a chip connected to at least one antenna. This chip is capable of receiving signals from at least four satellites equipped with several atomic clocks. By calculating the propagation times of these signals between the satellites and itself, it can determine its distance relative to the satellites and, using trilateration, precisely locate any point within the visibility range of the GPS satellites, in three dimensions.

This GPS module can be used for two specific applications. The first application is a guidance application, meaning that the GPS module is used in conjunction with navigation software to guide the user from a starting point to a destination. A second application is the option to use the GPS module in a tracking application, particularly for sports, thus enabling the user to see which route they have taken. The first application uses GPS to indicate the route to follow, while the second application is used to track the route travelled.

However, incorporating a GPS module into a watch is problematic. First, a GPS module consumes a great deal of electrical energy, such that the cells used in watches run down quickly. It is therefore necessary to have larger cells or to use more expensive rechargeable batteries.

The second problem is that these applications require a certain amount of computing power to function properly. However, increasing computing power requires the use of more powerful and energy-intensive processors.

Given these circumstances, there is clearly a need to find an alternative solution.

### SUMMARY OF THE INVENTION

One purpose of the present invention is to provide a navigation system in which a watch can alternately display horological information and guidance information via its hands, while efficiently managing its power consumption.

To this end, the invention relates to a navigation system configured to guide a user along an itinerary leading to a determined geographic location, the system comprising a watch and a wireless electronic geolocation device capable of generating guidance data relating to said itinerary, said watch comprising an electronic horology movement and a display interface that alternately implements a mode for displaying horological information and a mode for displaying guidance information resulting from said guidance data using at least a first hand and a second hand comprised in said interface, said guidance information relating to indications of a set direction to be followed to reach said geographic location and to an estimated travel time to the next change of direction.

In other embodiments:

the horology movement comprises a processing unit connected to an electronic compass, a communication module and at least one motor for driving the first hand of the horology movement, the processing unit executing a guidance algorithm in the guidance information display mode, pointing a free end of the first hand towards the set direction to be followed to reach said geographic location based on the guidance data received from the electronic device and the orientation data from the electronic compass.

the horology movement comprises a processing unit connected to an audio diffusion module and at least one motor for driving the hands, the processing unit executing a guidance algorithm in the horological information and guidance display modes, generating a visual and audio message notification to announce/warn of a change of direction.

the display interface comprises a time scale and the movement comprises the processing unit connected to said at least one motor for driving the second hand, said processing unit executing said guidance algorithm in the guidance information display mode, configuring the positioning of the second hand relative to said time scale comprised in the display interface by indicating the estimated travel time to the next change of direction.

in the guidance information display mode, the first hand can be rotated clockwise and counter-clockwise depending on the movement control instructions for this first hand generated by the processing unit according to the guidance data received from the electronic device and the direction data from the electronic compass.

in the guidance information display mode, the second hand is continuously driven with a uniform rotational movement only in the clockwise direction until it is superimposed on the first hand, where its movement stops, according to the movement control instructions for this second hand generated by the processing unit based on a calculation of the estimated time of the next change of direction.

said display interface comprises a dial, a flange and/or a bezel, each provided with a time scale;

said dial comprises a part including a screen configured to display guidance information relating to said geographic location, such as the topology of the intersections when the itinerary comprises a change of direction and to the time remaining to reach a destination on the itinerary corresponding to the geographic location.

the horology movement comprises a processing unit and a motor for driving said hands, said unit being capable of controlling the motor in order to position the hands to display the time or information relating to said geographic location.

the movement comprises a processing unit connected to sensors for measuring the movement that can be performed by the watch, the processing unit executing an algorithm for selecting the display mode according to a first movement of the watch specific to the selection of the guidance information display mode or to a second movement of this watch specific to the selection of the horological information display mode.

in the horological information display mode, the first hand is an hour hand and the second hand is a minute hand;

the electronic geolocation device is configured to generate guidance data relating to said itinerary, said data being transmitted to said watch.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 is a graphical drawing of a navigation system configured to guide a user along an itinerary leading to a geographic location, according to embodiments of the invention;

FIG. 2 shows a watch in the system configured in a horological information display mode, according to embodiments of the invention, and

FIGS. 3 and 4 show the watch in a mode displaying various horological information, according to different embodiments of the invention.

### DETAILED DESCRIPTION OF THE INVENTION

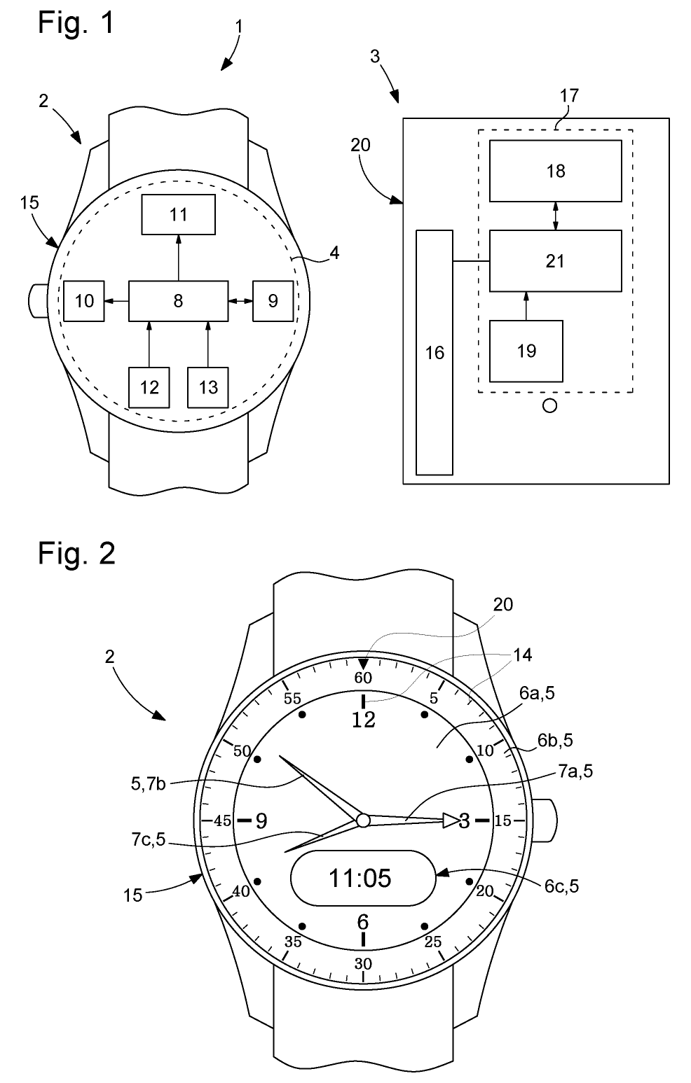

FIG. 1 shows a navigation system 1 configured to guide a user on an itinerary leading to a specific geographic location. Such a system 1 comprises a watch 2, in particular an electronic watch, and a wireless electronic geolocation device 3.

In this system 1, this device 3 is configured to generate a route, a trip or an itinerary, for guiding the user to the geographic location that is the destination or end of the journey. This device 3 can transmit guidance data relating to this itinerary to said watch 2. This data is to be used by the watch 2 to display or transmit guidance information to the user as the latter travels to the geographic location according to the itinerary generated by the device 3.

With reference to FIGS. 1 to 4, the watch 2 can display guidance information relating to the itinerary, in particular when the watch 2 is oriented so that the guidance information displayed by the watch 2 is within the user’s field of vision, the user being the wearer of said watch 2. It should be noted that this watch 2 can alternate between two display modes: a horological information display mode, such as displaying the time or date, and a guidance information display mode relating to a predetermined itinerary leading to the said geographic location.

In this system 1, the watch 2 comprises a case 15 with a wristlet. This case 15 contains an electronic horology movement 4 and a display interface 5.

Under these conditions, such a horology movement 4 comprises:

a processing unit 8 comprising a microcontroller;

a communication module 9;

an electronic compass 12;

measurement sensors 13 for measuring at least one movement that can be performed by the watch 2, such as an accelerometer and/or a gyroscope or even an inertial measurement unit with 3 to 6 axes;

an energy accumulator such as a cell or battery;

at least one motor 10 such as an electric micromotor or nanomotor, and/or

an audio diffusion module 11 comprising at least one loudspeaker.

In this system 1, the display interface 5 comprises elements that contribute to displaying/transmitting horological or guidance information. This interface comprises, but is not limited to, a dial 6a, a flange, a bezel 6b and hands. Such a dial 6a comprises a part including a screen configured to display guidance information relating, for example, to said geographic location, such as the topology of the intersections when the itinerary comprises a change of set direction and to the time remaining to reach a destination on the itinerary corresponding to the geographic location. This screen can use LCD or OLED display technologies.

In this configuration, the hands comprise a first hand 7a, a second hand 7b and a third hand 7c. When the watch 2 is configured in horological information display mode, the first, second and third hands 7a, 7b, 7c are respectively an hour hand, a minute hand and a second hand. When this watch 2 is configured in the horological information display mode, the first and second hands 7a and 7b are respectively a hand indicating the direction to follow and a hand indicating the estimated travel time until the next change of direction.

Each of these hands 7a, 7b is conventionally fitted at one of its ends on a corresponding rotation arbor arranged at the centre of the dial 6a so as to move above this dial 6a. This arbor or axis runs through the centre of the dial 6a, connecting the corresponding hand 7a, 7b to a motor 10. It should be noted that the processing unit 8 can control said at least one motor 10 to position the hands 7a, 7b to display horological information such as the time, an alarm, the date, or guidance information.

In this interface, the dial 6a, the flange and the bezel 6b can each comprise a visible part/face including a time scale 14 comprising time graduations, said time scale 14 being configured to engage with one of the two hands 7b, in particular permanently driven in a uniform rotational movement, to display a value relating to a duration, as will be seen hereinafter. In particular, such a dial 6a has time graduations on its outer edge, such as appliques and/or time indexes, representing hours and minutes conventionally.

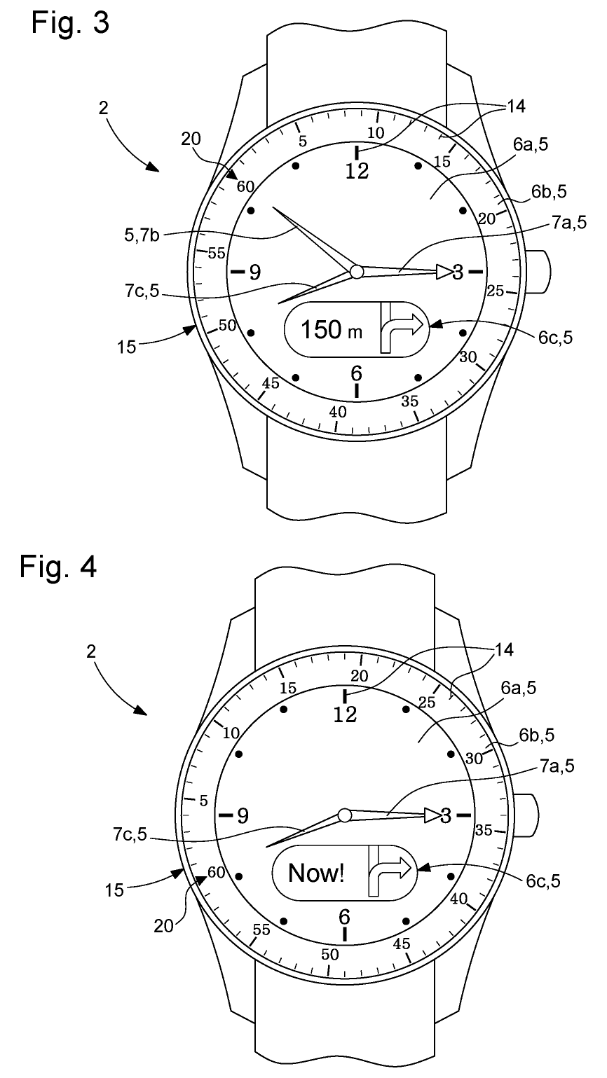

In this interface, the bezel 6b is a rotatable bezel. On this bezel 6b, the time graduations define a time interval strictly equal to one hour or even greater than one hour. On this bezel 6b, these time graduations can comprise an index for positioning said bezel 6b relative to the second hand 7b, this index forming the beginning and end of this time scale 14, this end also being indicated by the position of the first hand 7a. In the example shown in FIGS. 3 and 4, the time interval is one hour, and this time scale 14 is then graduated in five-minute increments. It is understood that in other variants, this time interval could be, in a non-limiting and non-exhaustive manner, two, four, five or even six hours. In the guidance information display mode, the second hand 7b can engage with the time scale 14 to give the user an estimate of the estimated travel time until the next change of direction.

As an alternative, this bezel 6b can be a digital display using LCD or OLED display technologies. In this configuration, the bezel 6b is connected to the processing unit 8. In this case, this bezel 6b can display different time graduations forming a time interval strictly equal to one hour or even greater than one hour. In the guidance information display mode, this time scale can be dynamic, being formed according to the estimated travel time to the next change of direction. In other words, the display of the graduation can be a function of this estimated time, in which case a time interval corresponding exclusively to this estimated time is then selected by the processing unit 8. By way of example, if this estimated time is sixty minutes, then the time interval will be strictly equal to sixty minutes with a time scale graduated in five-minute increments. Moreover, the graduation displayed can change as the distance to the next change of direction decreases. This time graduation can also be displayed in ascending or descending order according to a prior configuration in which the user wishes to know the time remaining until the next change of direction or the time elapsed since the last change of direction when heading towards the next change of direction.

Moreover, it should be noted that in the guidance information display mode, the second hand 7b, otherwise known as the “time before direction change indicator hand” or “direction change notification hand,” is driven:

continuously in a uniform and/or continuous rotational movement until it is arranged in a superimposed position with the first hand 7a, or

continuously in a uniform and/or continuous circular movement until it is arranged in a superimposed position with the first hand 7a, or

in a permanent uniform and/or continuous rotational movement until it is arranged in a superimposed position with the first hand 7a, or

in a permanent uniform and/or continuous circular motion until it is arranged in a superimposed position with the first hand 7a.

In this guidance information display mode, this rotational movement is carried out in a clockwise direction. This hand 7a is intended/dedicated solely and specifically to providing guidance information relating to an estimate of the travel time until the next change of direction; it therefore does not perform any other function on the watch 2 in this display mode.

In this horology movement 4, the processing unit 8 comprises a microprocessor and is connected to the communication module 9, to said at least one motor 10, to the electronic compass 12, to the audio diffusion module 11, to said measurement sensors 13 for measuring at least one movement that can be performed by the watch 2, and to the accumulator.

Such an electronic compass 12 comprises magnetic field sensors that provide detection signals. The sensor detection signals are first converted into digital signals in a traditional AC/DC converter before being sent to the microcontroller in the processing unit 8 for calculating the direction of magnetic North. In the case of an electronic compass 12 comprising two magneto-inductive sensors, the AC/DC converter is no longer necessary, as a simple controller can directly interpret the values measured by these two sensors.

In this horology movement 4, the communication module 9 enables wireless communication with the electronic geolocation device 3 using the same communication protocol, which can be Bluetooth, NFC or Wi-Fi.

The wireless electronic geolocation device 3 includes, but is not limited to: a portable GPS tracker, a smartphone, a laptop, a tablet computer or a phablet.

This device 3 comprises a case 20 in which a tactile or voice input element 16 and an electronic module 17 are arranged. This electronic module 17 is powered by an energy source and can perform a multitude of functions and display information on display means. This electronic module 17 comprises a microprocessor 21 and memory elements comprising, in particular, cartographic data. The electronic module 17 also comprises a locator unit 19, that is, a unit fitted with an antenna and capable of receiving positioning signals, which can be satellite or GSM signals, and of using them to provide geolocation information. The locator unit 19 can use the GPS, GLONASS or Galileo system 1, as well as an inertial navigation unit or a system 1 based on triangulation using radio waves (BLE, LTE).

The microprocessor 21 in the electronic module 17 is configured to execute a guidance algorithm capable of generating guidance data from geolocation information and from the itinerary produced from cartographic and topographic data, enabling the user of the watch 2 to be guided to the specified location that has been saved from the input element 16 of the device 3.

These guidance data comprise navigation information. Such information comprises, in a non-limiting and non-exhaustive manner, the following information components:

at least one indication of the estimated time until the next change of direction;

at least one indication of the change of direction;

at least one indication of the topology of each intersection included in the itinerary (crossroads, roundabout with multiple exits, junction, etc.).

It should be noted that the microprocessor 21 in the electronic module 17 calculates an estimate of the time until the next change of direction, taking into account:

a required/necessary reaction time on the part of the individual from the diffusion of the change of direction notification;

a reaction distance relative to the location of the change of direction in the itinerary, which is defined by the user, for example.

This reaction time and reaction distance can be configured using the input element 16 on the electronic device 3 or determined automatically by the electronic module 17 based on the topography of the itinerary and the user’s physical activity. This physical activity can be recorded in the device 3 using the input element 16 or automatically identified by the electronic module 17.

This device 3 further comprises a communication module 18 configured to communicate with said watch 2 using a communication protocol such as Bluetooth, NFC or Wi-Fi. This device 3 is therefore capable of exchanging data with said watch 2.

It should be noted that the guidance data is transmitted by the electronic device 3 to the watch 2 as soon as one of the information components is updated by the electronic module 17, depending on the evolution of at least one criterion of progression/gain of the individual and therefore of the watch 2 travelling on this itinerary, such as, in a non-limiting and non-exhaustive manner:

a variation in the direction taken by the user relative to the set direction, to account for an error in the individual's itinerary tracking and to suggest an alternative route to reach the geographic location;

a variation in the speed of progression along the itinerary to take into account the accelerations and stops made by the individual.

As previously mentioned, the watch 2 can alternate between the horological information display mode and the guidance information display mode with respect to the itinerary. More specifically, this alternation between these two display modes is controlled by the processing unit 8. Indeed, by executing a display mode selection algorithm, this processing unit 8 can determine the display mode in which to configure this watch 2 based on the movement data it receives from the sensors 13 measuring the movement that can be performed by the watch 2. In fact, by identifying a first specific movement of watch 2, the latter is then configured in the guidance information display mode, and by identifying a second specific movement of this watch 2, it is then configured in the horological display mode.

When the watch 2 is configured in a guidance information display mode, as soon as the processing unit 8 receives guidance information from the device 3, it generates control instructions for said at least one corresponding motor 10 to rotate the first hand 7a clockwise or counter-clockwise so as to point its free end in the set direction to be followed to reach said geographic location. Such instructions are generated by executing the guidance algorithm, which processes the guidance data received from the direction data of the electronic compass 12.

In this same display mode, when this guidance data is received from the device 3, it also generates control instructions for the corresponding said at least one motor 10 to rotate the second hand 7b in a clockwise or anti-clockwise direction, so as to position its free end relative to the time scale 14 on the dial 6a, on the flange or on the bezel 6b according to the estimated travel time until the next change in the set direction. Such instructions are generated by the execution of the guidance algorithm by the unit that processes the guidance data comprising this estimated time calculated by the device 3. Indeed, the microcontroller in this device 3 determines this estimated time by executing a guidance data generation algorithm using geolocation coordinate readings from this device 3 and therefore the watch 2, and the distance between the last coordinates read and the location of the next change of direction in the itinerary.

It should be noted that in the guidance information display mode, once this second hand 7b has been positioned relative to the time scale 14 according to the estimated time, this hand 7b is then continuously driven in a uniform rotational movement only in a clockwise direction until it is superimposed on the first hand 7a, where its movement stops. It is then repositioned relative to this time scale 14 in anticipation of the next change of direction.

When watch 2 is configured in the guidance information display mode or in the horology information display mode, when the processing unit 8 executes the guidance algorithm, it can generate a visual and audio notification to announce/warn of a change of direction based on the latest estimated time calculated for the next change of direction.

### Terminology

1. a system

2. a watch

3. an electronic geolocation device

4. an electronic horology movement

5. a display interface

6a. a dial

6b. a bezel

6c. a screen

7a. a first hand

7b. a second hand

7c. a third hand

8. a motion processing unit

9. a communication module

10. at least one motor

11. an audio diffusion module

12. an electronic compass

13. sensors for measuring at least one movement

14. a time scale

15. a watch case

16. a tactile or voice input element

17. an electronic module

18. a communication module

19. a locator unit

20. a device case

21. a microprocessor in the electronic module

1. A navigation system (1) configured to guide a user along an itinerary leading to a determined geographic location, the system (1) comprising a watch (2) and a wireless electronic geolocation device (3) capable of generating guidance data relating to said itinerary, said watch (2) comprising an electronic horology movement (4) and a display interface (5) that alternately implements a mode for displaying horological information and a mode for displaying guidance information resulting from said guidance data using at least a first hand (7a) and a second hand (7b) comprised in said interface (5), said guidance information relating to indications of a set direction to be followed to reach said geographic location and to an estimated travel time to the next change of direction.

2. The system (1) according to claim 1, wherein the horology movement (4) comprises a processing unit (8) connected to an electronic compass (12), a communication module (9) and at least one motor (10) for driving the first hand (7a) of the horology movement (4), the processing unit (8) executing a guidance algorithm in the guidance information display mode, pointing a free end of the first hand (7a) towards the set direction to be followed to reach said geographic location based on the guidance data received from the electronic device (3) and the orientation data from the electronic compass (12).

3. The system (1) according to claim 1, wherein the horology movement (4) comprises a processing unit (8) connected to an audio diffusion module (11) and at least one motor (10) for driving the hands (7a, 7b), the processing unit (8) executing a guidance algorithm in the horological information and guidance display modes, generating a visual and audio message notification to announce/warn of a change of direction.

4. The system (1) according to claim 1, wherein the horology movement (4) comprises a processing unit (8) connected to an electronic compass (12), a communication module (9) and at least one motor (10) for driving the first hand (7a) of the horology movement (4), the processing unit (8) executing a guidance algorithm in the guidance information display mode, pointing a free end of the first hand (7a) towards the set direction to be followed to reach said geographic location based on the guidance data received from the electronic device (3) and the orientation data from the electronic compass (12), the display interface (5) comprising a time scale (14) and the movement comprises the processing unit (8) connected to said at least one motor (10) for driving the second hand (7b), said processing unit (8) executing said guidance algorithm in the guidance information display mode, configuring the positioning of the second hand (7b) relative to said time scale (14) comprised in the display interface (5) by indicating the estimated travel time to the next change of direction.

5. The system (1) according to claim 1, wherein, in the guidance information display mode, the first hand (7a) can be rotated clockwise and counter-clockwise depending on the movement control instructions for this first hand (7a) generated by the processing unit (8) according to the guidance data received from the electronic device (3) and the direction data from the electronic compass (12).

6. The system (1) according to claim 1, wherein, in the guidance information display mode, the second hand (7b) is continuously driven with a uniform rotational movement only in the clockwise direction until it is superimposed on the first hand (7a), where its movement stops, according to the movement control instructions for this second hand (7b) generated by the processing unit (8) based on a calculation of the estimated time of the next change of direction.

7. The system (1) according to claim 1, wherein said display interface (5) comprises a dial (6a), a flange and/or a bezel (6b), each provided with a time scale (14).

8. The system (1) according to claim 1, wherein said display interface (5) comprises a dial (6a), a flange and/or a bezel (6b), each provided with a time scale (14), said dial (6a) comprising a part including a screen configured to display guidance information relating to said geographic location, such as the topology of the intersections when the itinerary comprises a change of direction and to the time remaining to reach a destination on the itinerary corresponding to the geographic location.

9. The system (1) according to claim 1, wherein the horology movement (4) comprises a processing unit (8) and a motor (10) for driving said hands (7a, 7b), said unit being capable of controlling the motor (10) in order to position the hands (7a, 7b) to display the time or information relating to said geographic location.

10. The system (1) according to claim 1, wherein the movement comprises a processing unit (8) connected to sensors (13) for measuring the movement that can be performed by the watch (2), the processing unit (8) executing an algorithm for selecting the display mode according to a first movement of the watch (2) specific to the selection of the guidance information display mode or to a second movement of this watch (2) specific to the selection of the horological information display mode.

11. The system (1) according to claim 1, wherein, in the horological information display mode, the first hand (7a) is an hour hand and the second hand (7b) is a minute hand.

12. The system (1) according to claim 1, wherein the electronic geolocation device (3) is configured to generate guidance data relating to said itinerary, said data being transmitted to said watch (2).
